(19) United States
(12) Patent Application Publication
(10) Pub. No.: US 2015/0285248 A1
(43) Pub. Date: Oct. 8, 2015

(54) ROTARY LOBE PUMP WITH WIPER BLADES

(71) Applicants: Randy Dixon, Billings, MT (US); Brett Howell, Spokane Valley, WA (US)

(72) Inventors: Randy Dixon, Billings, MT (US); Brett Howell, Spokane Valley, WA (US)

(21) Appl. No.: 14/746,493

(22) Filed: Jun. 22, 2015

Related U.S. Application Data
(63) Continuation-in-part of application No. 13/763,940, filed on Feb. 11, 2013, now Pat. No. 9,062,675.
(60) Provisional application No. 61/597,569, filed on Feb. 10, 2012.

(51) Int. Cl. F04C 15/00; F04C 18/12; F04C 29/00; F04C 2/12

(52) U.S. Cl. CPC F04C 15/0015; F04C 2/126; F04C 15/0019; F04C 15/0057; F04C 18/126; F04C 29/0042; F05C 2225/02; F05C 2225/06; F05C 2201/00

(57) ABSTRACT

A positive displacement rotary pump with an improved impeller design integrating replaceable wiper inserts. The impeller generally has one or more lobes and an equal number of conjugate surfaces. Each lobe has an arcuate peripheral end comprising a plurality of wiper blades. Each lobe further has a facial wiper blade on each face of the lobe. The wiper blades improve efficiency by making a seal with a pump chamber or the conjugate surface on the other impeller as it rotates. The wiper blades are arranged such that constant and successive contact between wiper blades and impellers is achieved.

### RELATED APPLICATIONS

This Non-Provisional patent application is a Continuation-in-Part of U.S. patent application Ser. No. 13/763,940, filed Feb. 11, 2013, which claims the benefit of priority from U.S. Provisional Patent Application No. 61/597,569, filed Feb. 10, 2012, the entire disclosures of which are hereby incorporated by reference in their entireties.

### FIELD OF THE INVENTION

The present invention relates to an improved semi-positive displacement rotary pump. More particularly, the pump has an improved impeller with replaceable wiper inserts in the impeller lobes to improve the efficiency and performance.

### BACKGROUND

The prior art includes many rotary pumps for pumping liquids such as water, oil, gasoline, and other materials. In such pumps, the tolerance of clearance between the impellers and the pump chamber is critical to the proper functioning of the pump. The clearance must be great enough so the impellers do not touch a pump chamber wall and destroy various components of the pump, yet small enough that the pump operates efficiently and with minimal vibration by pushing the liquid through the pump chamber. Moreover, such pumps must be made out of materials that can maintain the required critical tolerance and withstand extreme vibration. As such, rotary pumps are expensive to manufacture and may suffer from a lack of a high degree of tolerance. Furthermore, many rotary pumps are difficult and expensive to maintain since after excessive wear, the entire impeller(s) require replacement.

U.S. Pat. No. 1,348,772 to Auger, which is hereby incorporated by reference in its entirety, teaches the use of packing material, such as felt, on an end of each lobe of a rotary pump to help increase the efficiency of the pump. However, packing materials wear out quickly which reduces efficiency of the pump unless the packing material is replaced frequently. Additionally, materials such as felt are semi-porous which allows flow though the material and reduces efficiency. Furthermore, the packing material may come loose from the lobe at high speeds as the pump impellers rotate, which greatly reduces the efficiency of the pump, rendering it unusable.

U.S. Pat. No. 6,053,717 to Dixon discloses a rotary pump with a wiper feature incorporated in lobes of an impeller and is hereby incorporated by reference in its entirety. U.S. Pat. No. 6,053,717 to Dixon fails to disclose various novel aspects of the present invention including, for example, a pump whereby at least one wiper is in contact with at least one lobe throughout a full rotation (360°) of the pump. An impeller lobe is most efficient when in extremely close proximity with either a housing or another impeller. Without a small tolerance between the impeller lobe and either the housing or other impeller, excessive backflow occurs resulting in lower efficiency. Additionally, the interaction between the area where the surface of one lobe tip comes in close proximity with the other impeller can cause hydraulic hammering which causes vibration and unnecessary wear of the shaft bearings. A general need is recognized to reduce the void and increase the degree of contact and communication between the lobe tip and either the housing or other impeller while limiting vibration and damage to the pump.

Therefore, there is a need for a rotary pump having a high degree of tolerance which is relatively inexpensive to manufacture, maintains contact with either the interior chamber wall or other impeller, has an increased-wear replaceable wiper blades which does not come loose at high speeds, and which can be changed quickly and efficiently without significant expense.

### SUMMARY OF THE INVENTION

Therefore, it is an object of the present invention to improve the efficiency of a rotary pump and to reduce the manufacturing costs of making such a pump. It is a further object of the present invention to provide an improved impeller which has removable, extended-wear wiper blades which can be replaced quickly and cost effectively. Another object is to assure contact between the wiper blades and either the housing or other impeller by a spring or other biasing means and by the shape of the interior chamber wall and other impeller. Another object is that each wiper blade has a retention means which keeps the wiper blade attached to the impeller lobe during high rotational speeds of the impellers. A further object is to provide a more efficient path of action between two lobes and/or a housing by increasing the locus of successive contact points therebetween. Another object is to provide an improved impeller which has removable, extended-wear wiper inserts located on at least one periphery or face of an impeller lobe. Another object is to assure contact between each impeller lobe facial wiper blade and the pump housing by a spring or other biasing means.

In one embodiment of the present invention, a positive displacement rotary pump is provided with an improved impeller having a plurality of lobes, each of the lobes comprising a plurality of removable wiper blade inserts with a surface in substantially constant contact with the chamber wall of the pump. Such an impeller improves the efficiency of the pump while decreasing the manufacturing cost of the pump as a result of reduced tolerances between the pump chamber wall and the end of the wiper blade. Spring or biasing means provided in connection with the blades provide a force against the wiper insert within an impeller of the present invention, maintaining the wiper insert in substantially constant contact with the interior chamber wall of a pump or other impeller, even after significant wear of the wiper insert.

In another embodiment of the present invention, a positive displacement rotary pump is provided with an improved impeller having a plurality of lobes, each of the lobes comprising a plurality of removable wiper blade inserts with a surface in substantially constant contact with the chamber wall of the pump. Each lobe further comprises a first and second facial wiper blade wherein the first facial wiper blade extends outwardly and is positioned substantially perpendicular to the top plane of the impeller lobe and extends along the top plane of the impeller lobe such that it bisects the top plane of the lobe and the second facial wiper blade extends outwardly normal to the bottom plane of the impeller lobe and extends along the bottom plane of the impeller lobe such that it bisects the bottom plane of the lobe. Spring or biasing means provided in connection with the blades provide a force against the first and second facial wiper inserts within an impeller of the present invention, maintaining the facial wiper inserts in substantially constant contact with the top and bottom surfaces of the pump chamber housing, even after significant wear of the wiper insert.

In a preferred embodiment, an impeller comprises generally rounded lobes for increasing contact points and creating a longer path of action with respect to additional components. The generally rounded lobes comprise wiper inserts disposed generally radially thereon. Wiper inserts are preferably distributed on a lobe at even radial spacing. In one embodiment, three wiper inserts are disposed along a radial terminus of a lobe. It will be expressly recognized, however, that the present invention is not limited to a three-wiper arrangement. It is contemplated that lobes of the present invention may comprise any number of wiper inserts on a lobe terminus.

In another embodiment, an impeller comprises generally rounded lobes for increasing contact points and creating a longer path of action with respect to additional components. The generally rounded lobes comprise wiper inserts disposed generally radially thereon as well as a first and second facial wiper insert. Wiper inserts are preferably distributed on a lobe at even radial spacing. In one embodiment, three wiper inserts are disposed along a radial terminus of a lobe. It will be expressly recognized, however, that the present invention is not limited to a three-wiper arrangement. It is contemplated that lobes of the present invention may comprise any number of wiper inserts on a lobe terminus. Similarly, facial wiper inserts are preferably distributed such that the first facial wiper blade extends outwardly normal to the top plane of the impeller lobe and extends along the top plane of the impeller lobe such that it bisects the top plane of the lobe and the second facial wiper blade extends outwardly normal to the bottom plane of the impeller lobe and extends along the bottom plane of the impeller lobe such that it bisects the bottom plane of the lobe.

In one embodiment, a pump is provided with a plurality of wiper inserts where each of the wiper inserts comprise a biasing member for biasing the wiper inserts in a radially outward manner thereby facilitating contact between wiper inserts and lobe features.

The present invention provides a novel timing sequence of a plurality of pump lobes which, in various embodiments, enables the pump to run dry for an indefinite time period without adversely affecting the pump components.

These and other advantages will be apparent from the disclosure of the invention(s) contained herein. The above-described embodiments, objectives, and configurations are neither complete nor exhaustive. As will be appreciated, other embodiments of the invention are possible using, alone or in combination, one or more of the features set forth above or described in detail below. Further, the summary of the invention is neither intended nor should it be construed as being representative of the full extent and scope of the present invention. The present invention is set forth in various levels of detail in the summary of the invention, as well as, in the attached drawings and the detailed description of the invention and no limitation as to the scope of the present invention is intended by either the inclusion or non-inclusion of elements, components, etc. in this summary of the invention. Additional aspects of the present invention will become more readily apparent from the detailed description, particularly when taken together with the drawings.

### BRIEF DESCRIPTION OF THE DRAWINGS

Those of skill in the art will recognize that the following description is merely illustrative of the principles of the disclosure, which may be applied in various ways to provide many different alternative embodiments. This description is made for illustrating the general principles of the teachings of this disclosure invention and is not meant to limit the inventive concepts disclosed herein.

The accompanying drawings, which are incorporated in and constitute a part of the specification, illustrate embodiments of the disclosure and together with the general description of the disclosure given above and the detailed description of the drawings given below, serve to explain the principles of the disclosures.

It should be understood that the drawings are not necessarily to scale. In certain instances, details that are not necessary for an understanding of the disclosure or that render other details difficult to perceive may have been omitted. It should be understood, of course, that the disclosure is not necessarily limited to the particular embodiments illustrated herein.

The present invention has significant benefits across a broad spectrum of endeavors. It is the applicant's intent that this specification and the claims appended hereto be accorded a breadth in keeping with the scope and spirit of the invention being disclosed despite what might appear to be limiting language imposed by the requirements of referring to the specific examples disclosed. To acquaint persons skilled in the pertinent arts most closely related to the present invention, a preferred embodiment of the method that illustrates the best mode now contemplated for putting the invention into practice is described herein by, and with reference to, the annexed drawings that form a part of the specification. The exemplary method is described in detail without attempting to describe all of the various forms and modifications in which the invention might be embodied. As such, the embodiments described herein are illustrative, and as will become apparent to those skilled in the arts, can be modified in numerous ways within the scope and spirit of the invention, the invention being measured by the appended claims and not by the details of the specification.

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

It should be understood that the drawings are not necessarily to scale. In certain instances, details that are not necessary for an understanding of the invention or that render other details difficult to perceive may have been omitted from these drawings. It should be understood, of course, that the invention is not limited to the particular embodiments illustrated in the drawings.

FIG. 1 is a top view of rotary impellers within a housing;

FIG. 2 is a side view of a wiper blade according to one embodiment;

FIG. 3 is a side view of a wiper blade according to one embodiment;

FIG. 4 is a front view of a wiper blade according to one embodiment;

FIG. 5 is a perspective view of a wiper blade according to one embodiment;

FIG. 6 is an exploded perspective view of a wiper blade assembly according to one embodiment;

FIG. 7 is an exploded perspective view of one embodiment of the present invention;

FIG. 8 is a front perspective view of one embodiment of the present invention;

FIG. 9 is a rear perspective view of a wiper blade according to one embodiment of the present invention;

FIG. 10 is a front perspective view of a facial wiper insert according to one embodiment of the present invention;

FIG. 11 is a perspective view of a facial wiper insert biasing means according to one embodiment of the present invention;

FIG. 12 is a cross-sectional view of an impeller according to one embodiment of the present invention; and

FIG. 13 is an exploded perspective view of one embodiment of the rotary lobe pump of the present invention.

### DETAILED DESCRIPTION OF THE INVENTION

The present invention generally relates to an improved semi-positive displacement rotary pump. More particularly, the present invention provides an improved impeller for use in a rotary pump.

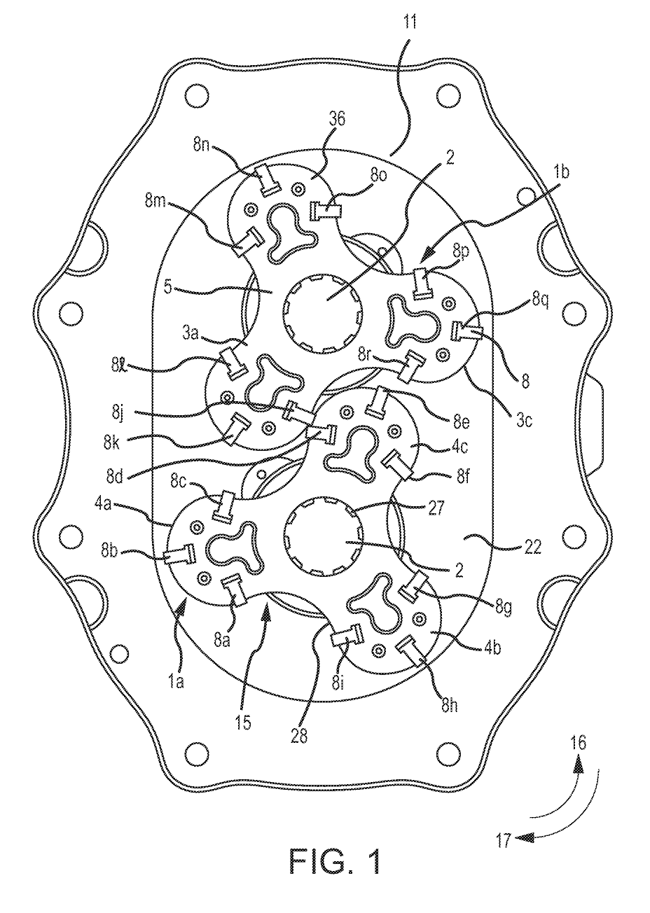

Referring now to FIG. 1, impellers 1a, 1b are provided with a plurality of wiper inserts 8 which are secured about a periphery of one or more impeller lobes 3. In one embodiment, the wiper inserts 8 are operatively positioned near or within a cavity 10 of the impeller lobe 3 such that the wiper insert 8 is in direct contact with an interior chamber wall 11 of a pump chamber 22 or a substantially arcuate cut-out portion of the other impeller. Thus, the efficiency of the pump is improved compared to conventional rotary pumps which require a gap between the end of the impeller lobe peripheries 4 and the chamber wall 11 or other impeller to prevent excessive vibration.

One advantage of the improved impeller for a rotary pump of the present invention is that the close tolerances of the clearance of the impellers 1a, 1b and the pump chamber 11 are not critical due to the impeller and wiper blade 8 design. In contrast, manufacturing tolerances which allow for the clearance of impellers 1a, 1b and pump chamber walls 11 as shown in the prior art are very critical. In these pumps, if the components are not within tolerance, the pump will not work due to loss of suction capacity and/or excessive vibration. In the pump of the present invention, the tolerances are not as critical, because the wiper insert is biased to extend outward from the lobe periphery 4 until prevented by the retention means which interferes with a wiper insert stop. This ability to extend to varying degree allows the wiper blade 8 to remain in substantial constant contact with the pump chamber wall 11 or other impeller assures peak efficiency.

FIG. 1 illustrates the ability for the wipers to mask large manufacturing tolerances. If the impellers 1a, 1b were perfectly centered within the interior chamber wall 11, the extension would be the same for each wiper insert 8 as it passes the chamber wall 11. As shown in FIG. 1, the wiper inserts 8 remain in contact with the chamber wall 11 even though the distance between the lobe tip 4 and the chamber wall 11 changes.

Therefore, the pump of the present invention is less expensive to produce and can be made from a wider variety of materials than pumps previously utilized for similar uses. Prior to the present invention, similar pumps had to be made out of certain metals such as cast iron, aluminum, bronze, brass, and ferrous type metals, because the tolerances and the need to minimize vibration of the pump were critical. However, the wiper insert 8 improvement of the present invention allows the pump to be constructed with lower tolerances (i.e., greater distance between the pump chamber wall 11 and the impeller peripheries 3, 4). Thus, the pump can be made out of numerous types of materials, including, but not limited to, cast iron, bronze, stainless steel, fiberglass, plastic, aluminum, engineered polymers, thermoplastics, rubber composites, foam rubber and ferrous type metals.

As further shown in FIG. 1a, 1b impellers 1 are provided with a plurality of wiper inserts 8a-8s such that at least one wiper insert is in contact with a corresponding impeller at all times during pump operation. Whereas known devices provide wipers which do not provide constant contact, the present invention provides a novel arrangement of wiper features whereby the wipers 8a-8s are rotationally dispersed along the periphery 3, 4 of a lobe such that at least one wiper is in contact with at least one lobe regardless of rotational position of the impeller(s) 1a, 1b.

For example, and still referring to FIG. 1, an impeller 1a according to one embodiment comprises three lobes 4a, 4b, 4c, each of said lobes comprising three wiper inserts 8. At the position shown, wiper 8c is in contact with a lobe 3a of the opposing impeller 1b. As impeller 1a rotates in a counter-clockwise manner, for example, opposing impeller 1b will co-rotate in a clock-wise manner. Upon such rotation, wiper insert 8d will rotate out of contact with the lobe 3a of impeller 1b. Prior to complete disengagement between wiper insert 8d and lobe 3a, however, wiper insert 8e will rotate to contact impeller 1a. Similarly, prior to wiper insert 8j disengaging from impeller 1a, a succeeding wiper insert 8e will contact the lobe 3c and/or arcuate cut-out portions 15 of impeller 1b. One of skill in the art will recognize that this progression will continue from one insert 8 to the next and from one lobe to the next in such a manner that at least one wiper insert 8 is in contact with a lobe at all rotational positions of the pump. It will be further recognized that the number and placement of wiper inserts 8 may be varied without deviating from the scope or spirit of the present invention. Thus, it will be expressly recognized that pumps of the present invention are not limited to impellers having three lobes and/or three wiper inserts disposed on said lobes.

Yet another advantage of the improved rotary pump of the present invention is that the suction capability of the pump may be significantly and reliably increased over the suction capability of other rotary pumps since the wiper inserts of the present invention are more efficient, non-porous and wear evenly. A tighter seal is created during rotation because of constant contact of the wiper blade insert 8 with the chamber wall 11, which improves pump efficiency over the life of the wiper insert.

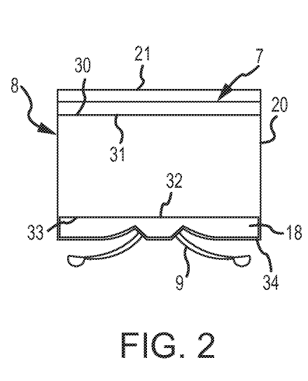

As shown in FIG. 2, a spring or biasing means 9 improves the wear life of the blade 7 because it will extend the wiper insert as the blade 7 wears. Additionally, there is little chance the wiper insert 8 will detach from a lobe periphery at high speeds because of the interaction between the retention means 18 and a wiper stop 12 within the cavity 10 (see. FIG. 7). Subsequently, the pump suction performance is increased along with output performance and reliability.

Another advantage of the improved rotary pump of the present invention is that the wiper insert 8 is easy to replace, making it possible to maintain a tight seal for the life of the pump. Wiper inserts 8 of the present invention can be manufactured from a variety of materials including, but not limited to, rubber, nitrile, viton, polymers, nylon based resins, foam rubber, teflon and any other material which is generally wear-resistant and conducive to frictionally engage the surface of the pump chamber wall. Such a material can be selected to be compatible with materials from which the pump chamber wall 11 and impeller is constructed. Preferably, the wiper insert 8 is additionally compatible with the fluid serviced through the pump and thus custom designed for the particular pump application.

As shown in FIGS. 1 and 7, a rotary pump of the present invention can have one or more impellers 1a, 1b. In a preferred embodiment, a pump of the present invention has two axially symmetrical impellers. Each impeller 1 can turn either a forward 16 or reverse 17 direction which will define the flow of fluid through the pump. Normally, the fluid flows from a fluid inlet to the fluid outlet, but the flow direction may be changed by reversing the rotation direction of the impellers. In certain embodiments, each shaft 2 is independently driven so the impellers 1 do not touch each other nor do the lobes 3, 4 of the impellers 1 touch the pump chamber wall 11. The impellers 1 are designed to fit within the chamber of the pump 22. There must be clearance between the lobe 3, 4 peripheries of the impeller 1a, 1b and the pump chamber wall 11 because, as described above, the tolerance of this clearance is not critical due to the novel wiper blade 7 features. Enough clearance is provided between the lobe periphery and the chamber wall 11 for the wiper blade 7 at minimum extension.

Impellers of the present invention can have one or more lobes 3, 4. Preferably, an impeller of the present invention comprises three lobes. Each lobe 3, 4 of the impeller 1 has a first end or periphery, located proximal to the pump chamber wall 11, and a second end 5, located proximal to a central axis 2. The lobes 3 are commonly disposed approximately 120° apart in a preferred embodiment.

Each impeller 1 has a plurality of substantially arcuate cut-out portions 15. Each of the substantially arcuate cut-out portions 15 has a conjugate surface 28. The wiper insert 8 forms one or more seals over the conjugate surface 28.

The interaction between the wiper blade 7 and the conjugate surface 28 as the impellers 1 rotate, as well as the constant contact achieved therebetween, provide higher pump efficiency without any hydraulic hammering effect which causes unwanted vibration in the prior art.

According to one embodiment, each lobe periphery 4 has an interconnection means for securing a wiper insert 8 within a lobe. In certain embodiments, interconnection means are formed to removably, yet securely, hold the wiper insert 8 of the present invention such that the wiper insert 8 extends beyond the impeller lobe periphery and is maintained in substantially constant contact with the pump chamber wall 11 and/or conjugate surface 28 during rotation of the impeller. Insertion and assembly of the wiper blades are further shown in FIG. 7.

Referring now to FIGS. 2-5, wiper inserts 8 according to certain embodiments of the present invention comprise a shape adapted to fit securely to the interconnection means. Preferably, the wiper insert 8 comprises the blade 7, elongated portion 20, retention means 18, and biasing means 9. Referring to FIG. 2, the wiper blade 7 has a distal edge 21 and proximal end 30. The elongated portion 20 has an outward end 31 and an inward end 32, with the outward end 32 attached to the proximal end 30 of the wiper blade. The retention means 18 has a primary end 33 and secondary end 34 where the primary end 33 is connected to the inward end 32 of the elongated portion 20. The wiper blade 7 can be of any form capable of maintaining substantially constant contact with the pump chamber wall 11 or conjugate surface 28 when attached to an impeller lobe. The blade portion 7 is joined to the elongated portion 20 of the wiper insert 8 such that the edge 21 of the blade 7 is in substantially constant contact with the pump chamber wall 11 or conjugate surface 28.

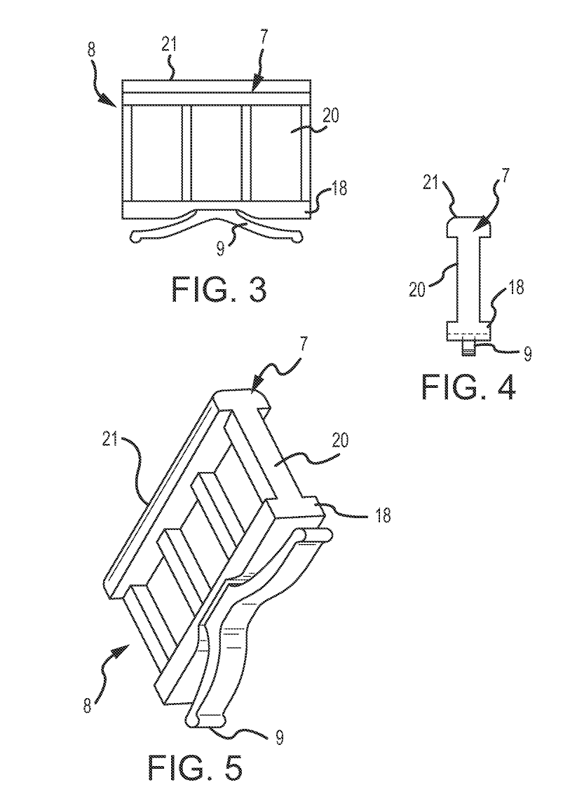

FIGS. 3-5 depict one embodiment of a wiper insert 8 according to the present invention. FIG. 3 is a front plan view thereof. FIG. 4 is a side elevation view thereof. FIG. 5 is a bottom perspective view thereof. As shown, biasing means 9 are provided to bias the insert 8 outwardly toward a pump chamber wall and/or an opposing impeller (not shown). An elongated portion 20 of the insert comprises ribs and/or cut-out portions to reduce weight of the insert, and thus providing a more responsive movement of the insert 8 as impacted by the biasing means 9 and any external forces. A blade portion 7 is provided, having a partially rounded shoulder. The edge 21 of the blade 7 is adapted for contacting pump chamber and impeller features as shown and described herein, thus increasing efficiency of a pump.

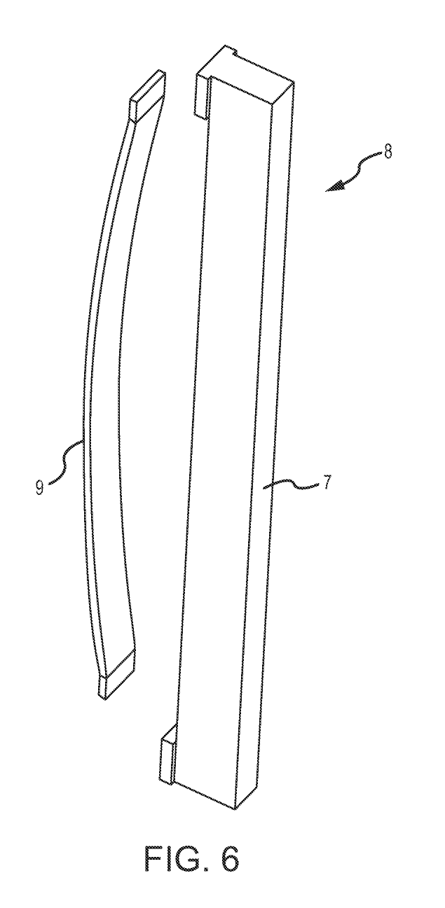

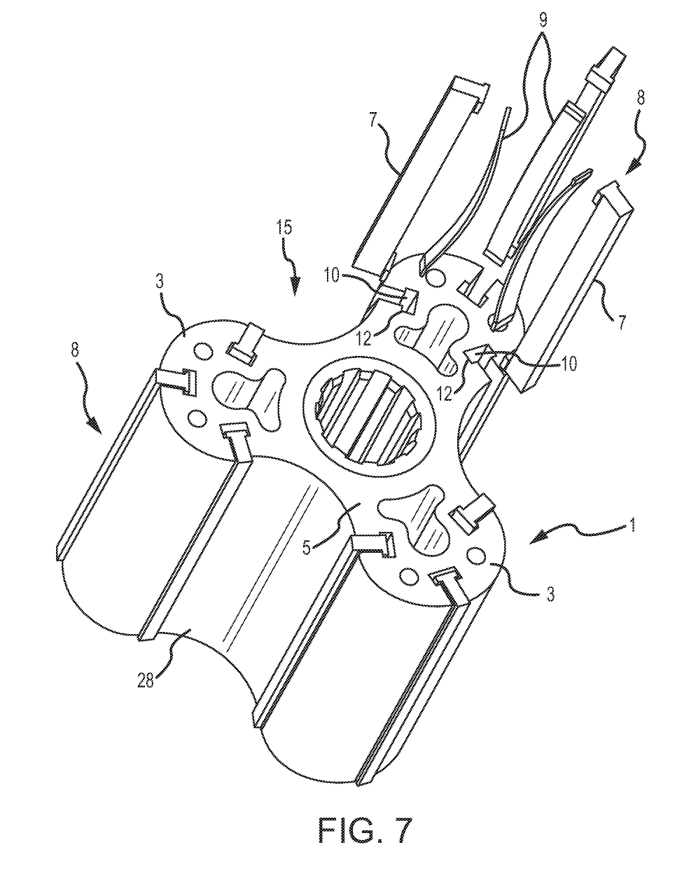

FIG. 6 is an exploded perspective view of a wiper insert 8 according to a preferred embodiment of the present invention. As shown, the wiper insert 8 comprises a biasing element 9 which is in the form of a leaf spring and a wiper blade 7. When assembled, the blade 7 is biased outwardly due to the biasing force of the element 9 and its contact with a portion of a pump lobe. As used herein, the term “bias” refers to either linear or non-linear bias and should not be read or interpreted as being limited to one or the other. Peripheral ends of the biasing element 9 may be inserted into corresponding ends of the wiper 7 to create a pre-tensioned state and/or secure the biasing element 9 to the wiper 7. Accordingly, in one embodiment, it is contemplated that the biasing element 9 is secured within the wiper 7 via slots or tracks in the wiper 7. In alternative embodiments, it is contemplated that the biasing member 9 is secured to the wiper 7 via a variety of known devices, means, and methods including, but not limited to, various fasteners.

FIG. 7 is a partially exploded perspective view of an impeller 1 having lobes 3, each of the lobes 3 having wiper inserts 8. For illustration purposes, FIG. 7 shows one lobe 3 with wiper inserts 8 in an unassembled state. Wiper inserts 8, including biasing elements 9 and blades 7, may be assembled and inserted into a cavity provided in the lobe 3. Accordingly, the present invention provides for a wiper insert 8 that may be assembled, removed, repaired and/or replaced with relative ease.

FIG. 7 provides a perspective view of an impeller 1 with a plurality of lobes 3, each of the lobes 3 comprising a plurality of wiper inserts 8. The wiper inserts comprise a blade portion 7 and a biasing portion 9. Biasing portion and/or at least a portion of the blade 7 are received within interconnection means which, in at least one embodiment, comprise slots 10 with one or more shelf features 12 to prevent radial dislocation of the insert(s) 8. The interconnection means generally comprise channels that extend along a depth of the impeller 1 and are substantially equivalent in length to the insert(s) 8.

Interconnection means, however, can be any shape, geometry, or arrangement suitable for holding the wiper insert 8 of the present invention in such a manner. Preferably, interconnection means comprise one or more cavities. The cavities comprise a narrow opening at a most distal edge of the lobe periphery such that the blade 7 of the wiper insert 8 is projected through the opening, while at least a portion of the blade member 7 and biasing member 9 is positioned within the cavity or channel.

In one embodiment, an impeller of the present invention has a biasing means 9 which is situated between the wiper insert and a back edge of the wiper insert cavity 10. The biasing means 9 provides substantially constant pressure on the wiper insert 8 such that the wiper insert 8 is pushed toward a pump chamber wall 11 or conjugate surface 28. That is, the biasing means 9 when compressed will have a tendency to expand outwardly toward the chamber wall 11 or conjugate surface 28. This biasing provides for extended wiper blade 7 life and improved pump efficiency. In one embodiment, the biasing means 9 comprises a mechanical type spring. Such a biasing element can be metal, plastic, rubber, or any similarly appropriate material. In another embodiment, the biasing means 9 comprises the material utilized for the wiper insert 8 as shown in FIGS. 2-5. The biasing means 9 can be rated at different tensions to accommodate wear factors of different materials. These materials include, but are not limited to rubber, nitrile, viton, teflon, polymers, nylon based resins, foam rubber, or any material with expansive properties.

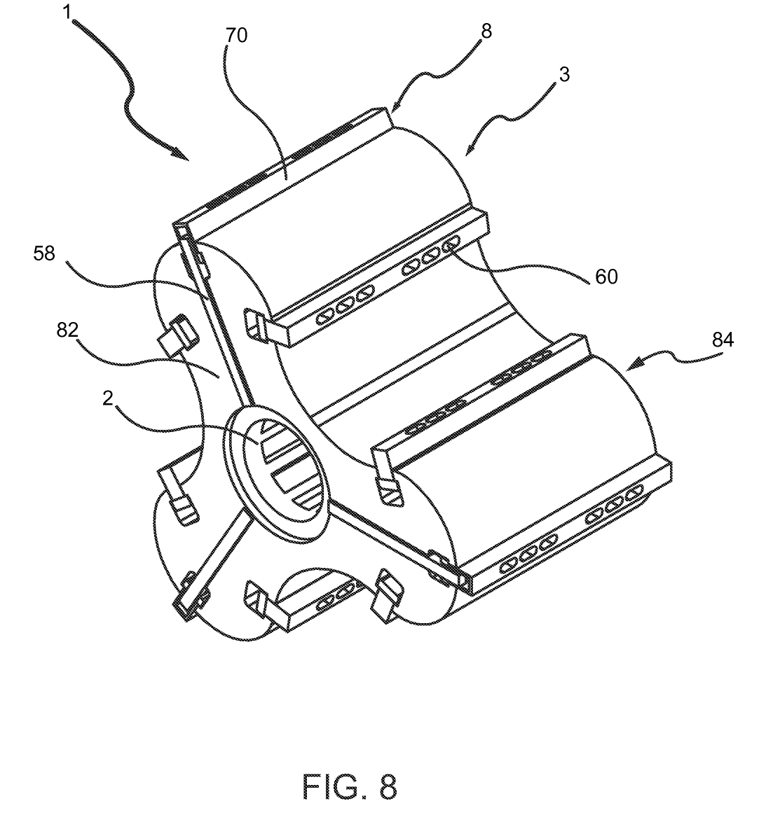

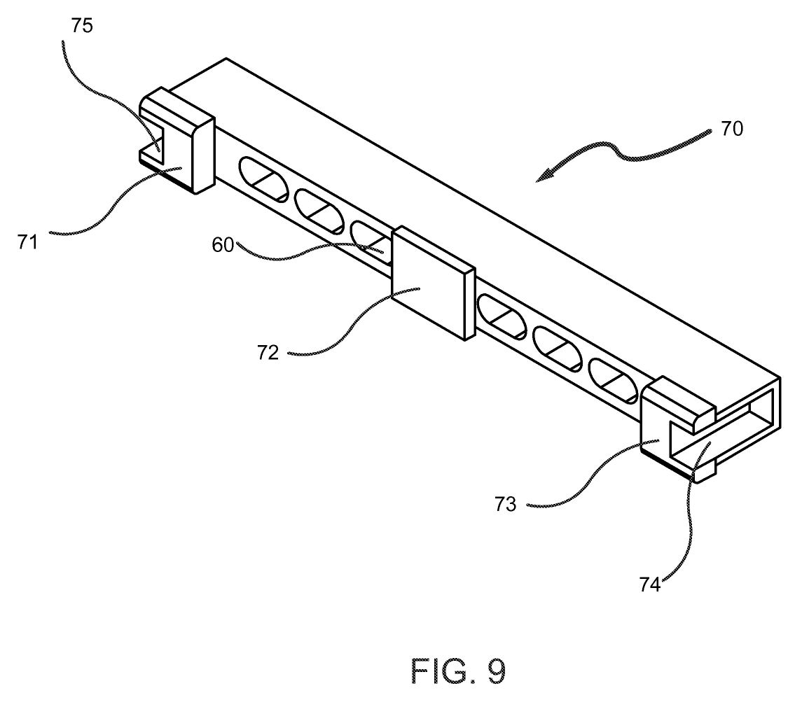

FIG. 8 is a front perspective view of one embodiment of an impeller of the present invention. As shown, an impeller 1 is provided with a plurality of lobes 3 having a top planer surface 82 and bottom planer surface 84, each of the lobes 3 comprising a plurality of wiper inserts 8. In the present embodiment, the wiper blades 70 used are those of the embodiment shown in FIG. 9 rather than the embodiment shown in FIGS. 1-7. However, one skilled in the art will recognize either embodiment of the wiper blades 7, 70 may be utilized in the embodiment of FIG. 8.

In addition, each lobe 3 in this embodiment has facial wiper inserts 58 located on each plane 82, 84 of the lobe 3, which extend between the shaft 2 of the impeller 1 and the end of the lobe 3 such that the facial wiper inserts 58 bisect the lobe 3. Further, each facial wiper insert 58 protrudes outward and substantially normal to the plane of the each lobe plane 82, 84. The various components of the embodiment according to FIG. 8 are discussed further with reference to FIGS. 9-11, below.

One advantage of the embodiment of FIG. 8 is additional contact between the impeller 1 and the pump chamber. This increased contact between the impeller 1 and the pump chamber prevents fluid from passing over either of the planes 82, 84 of the impellers 1 as they rotate. This has the additional benefit of further increasing the suction capability of the pump due to the contact between the facial wiper inserts 58 and the pump chamber. Additionally, the facial wiper inserts 58 can be removed from the lobes 3 for easy maintenance and replacement. Preferably, the facial wiper inserts 58 are selectively interconnected within a channel provided in the lobe plane 82, 84. This channel extends along a depth of the impeller 1 and is substantially equivalent in length to the facial wiper inserts 58. However, one skilled in the art would recognize that the interconnection means can be any shape, geometry, or arrangement suitable for holding the facial wiper insert 58 of the present invention in such a manner. The facial wiper insert 58 may additionally have protrusions along the bottom face of the facial wiper insert 58, which mate with the track or channel provided in the lobe 3 to keep the facial wiper insert 58 in place.

FIG. 9 is a rear perspective view of another embodiment of a wiper blade 70 used with the present invention. As shown, the wiper blade 70 has a plurality of apertures 60 located along the blade 70 face which extend through the body of the blade 70. In a preferred embodiment, each blade 70 has two sets of three apertures 60 located along the blade 70. However, one skilled in the art will recognize that there can be any number of apertures which can be arranged in any number of combinations. The apertures 60 serve to further reduce the weight of the blades 70 and provide more responsive movement and increased interaction with a biasing means to keep the blades 70 in contact with the pump chamber wall and the other impeller.

The blade 70 also has 3 protrusions 71, 72, 73 extending outwardly from the bottom plane of the blade 70. While this embodiment employs three protrusions 71, 72, 73, one skilled in the art would recognize that a variable number of protrusions could be employed. These protrusions 71, 72, 73 act to secure the blade 70 to the impeller lobe via a track embedded in the impeller lobe. The blades 70 of the present embodiment located at the end of the impeller lobe further have two cavities 74, 75 present at each end of the blade 70. The purpose of these cavities 74, 75 is to allow mating with the facial wiper blades 58. One skilled in the art will recognize, however, that these cavities 74, 75 are only employed in the impeller embodiment which utilizes the facial wiper inserts 58. When the blade 70 is used in the embodiment without facial wiper inserts 58, as show in FIG. 7, no cavities 74, 75 are present.

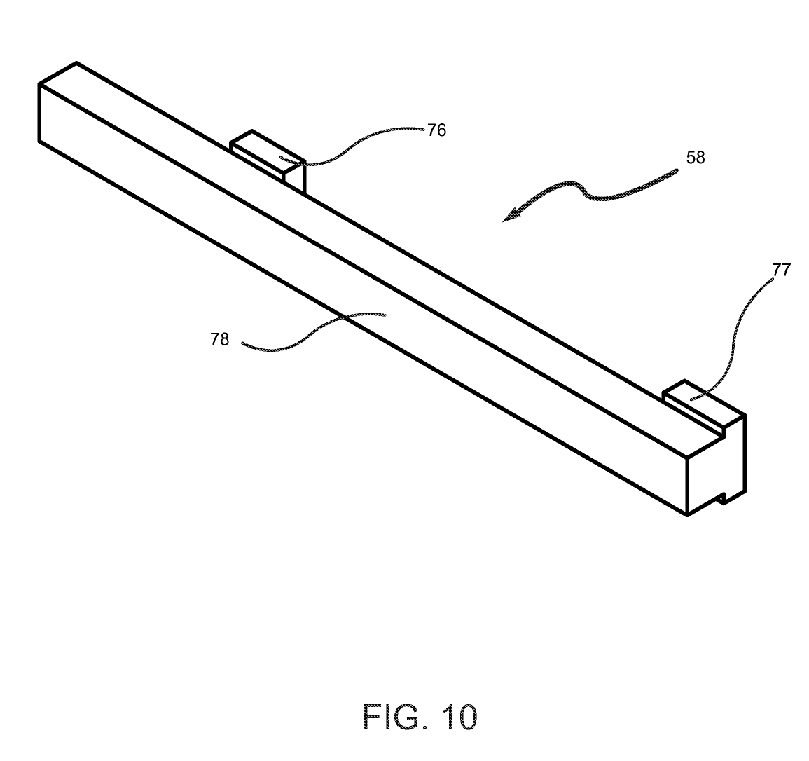

FIG. 10 depicts a facial wiper insert 58 according to another embodiment of the present invention. The facial wiper insert has an elongated surface 78 which extends outwardly and substantially perpendicular to the face of the impeller lobe and is in contact with the pump housing. The facial wiper insert 58 additionally has two protrusions 76, 77 which secure the facial wiper insert 58 to the impeller lobe via a track. While the present embodiment utilizes two protrusions, one skilled in the art would recognize that a variable number of protrusions could be utilized. Facial wiper inserts 58 of the present invention can be manufactured from a variety of materials including, but not limited to, rubber, nitrile, viton, polymers, nylon based resins, foam rubber, teflon and any other material which is generally wear-resistant and conducive to frictionally engage the pump chamber.

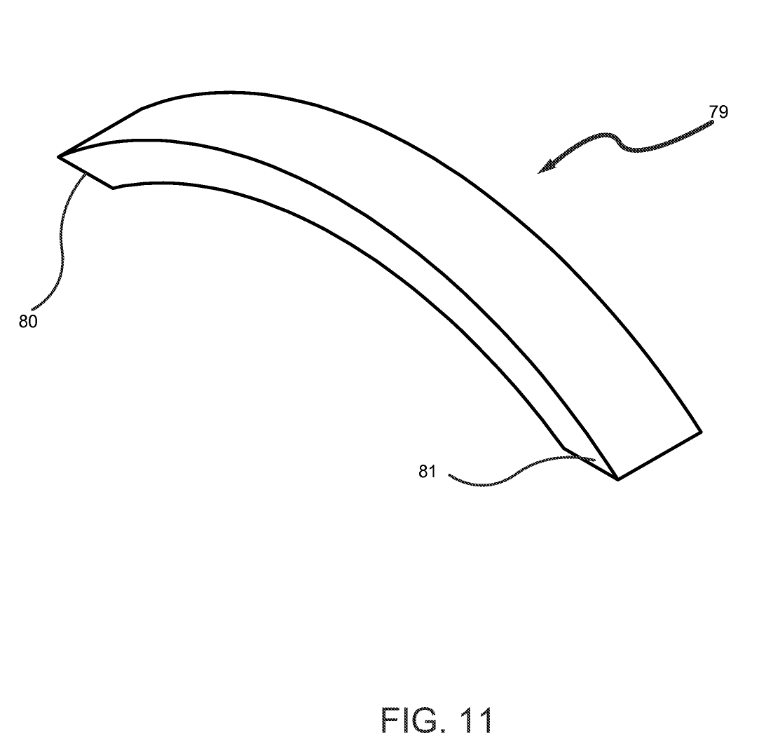

FIG. 11 depicts a biasing means, more specifically a spring 79 which is utilized in conjunction with the facial wiper inserts 58 in order to bias the facial wiper inserts 58 outwardly such that they maintain contact with the pump housing. While the present embodiment utilizes a leaf spring, one skilled in the art would recognize that a variety of biasing means could be utilized such as a mechanical spring. The spring 79 has two ends 80, 81 which make contact with the inside surfaces of the protrusions located on the base of the facial wiper inserts 58. This allows the spring 79 to continually bias the facial wiper inserts 58 outward such that they remain in contact with the pump chamber.

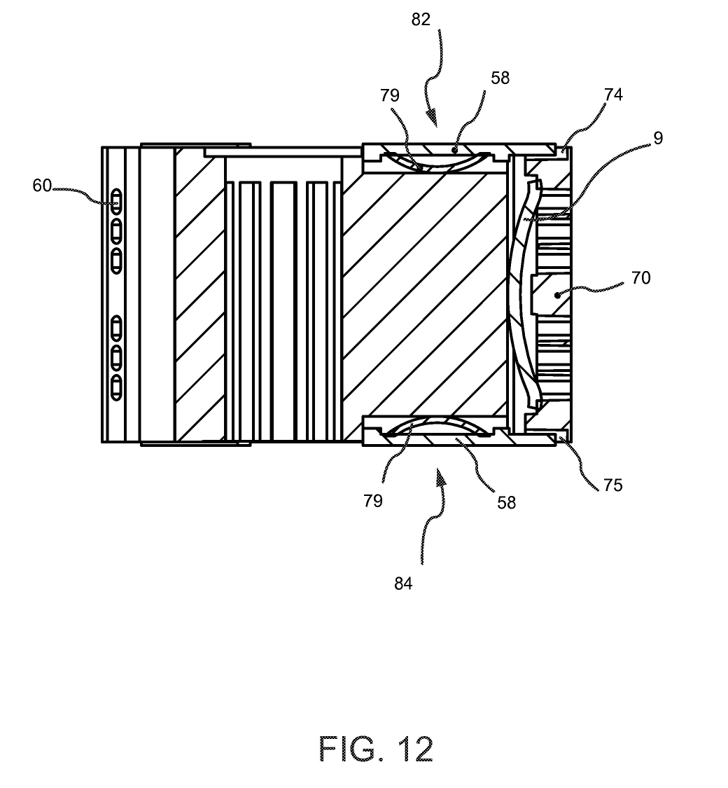

FIG. 12 depicts a cross-sectional view of the impeller shown in FIG. 8. FIG. 12 shows the interaction of the facial wiper inserts 58 with the spring 79, impeller lobe planes 82, 84, and the cavities 74, 75 of the wiper blade 70. As shown, the spring 79 and the facial wiper inserts 58 make contact such that the two ends of the spring are in contact with the inside surfaces of the two protrusions of the facial wiper inserts 58. This ensures that the spring 79 will continue to bias the facial wiper inserts 58 outward such that they remain in contact with the pump chamber. Similarly, the wiper blade 70 also utilizes a spring 9 in order to bias the wiper blade 70 outward such that it remains in constant contact with the pump chamber walls.

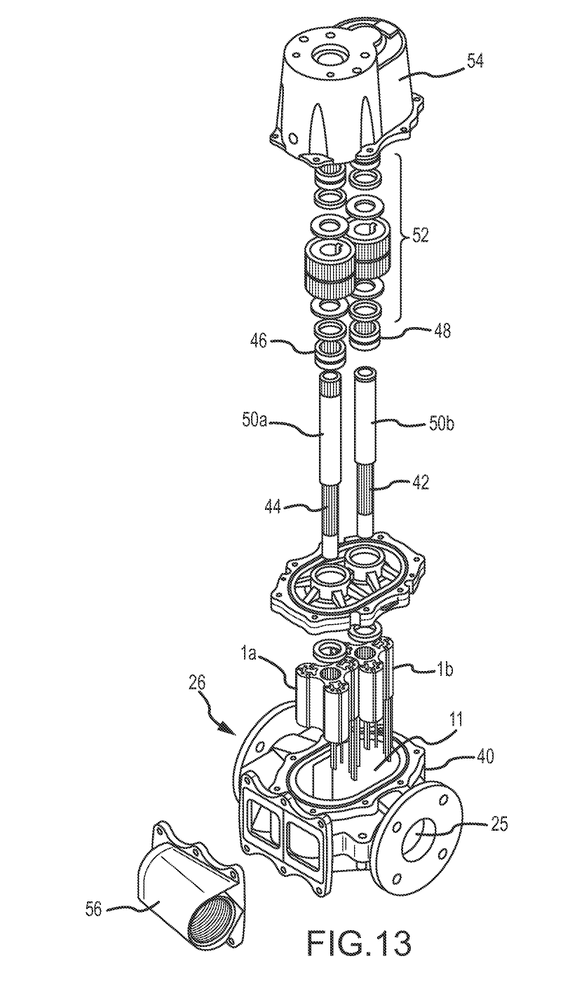

A preferred embodiment of a rotary pump of the present invention is depicted in FIG. 13. As shown, a semi-positive displacement, gear driven, rotary pump is shown which is timed and synchronized, with independently timed impellers 1a, 1b. The pump comprises a cylindrical housing 40 generally having arcuate interior chamber walls 11. The walls are separated by a fluid inlet space joined to a fluid inlet 25. The rotary pump of the present invention can be made with virtually any size inlet 25 and outlet 26 depending on the application. The pump of the present invention has a motorized or hand driven pump head coupled axially to the shafts 42, 44 to rotate the impellers 1a, 1b and impart mechanical energy to the fluid. While the pump shown in FIG. 13 utilizes the impeller lobes 1a, 1b described by FIGS. 1-7, one skilled in the art would recognize that the pump can also utilize the impeller lobes as described in FIGS. 8-12.

Bearings are used in a pump of the present invention to reduce friction. Such bearings are coupled, for example, to the axial shafts 42, 44. Preferably, the pump of the present invention comprises needle bearings 46, 48. Needle bearings used in a pump of the present invention provide significant advantages. For example, needle bearings are manufactured to hold closer tolerances, extend the life of the pump significantly, and allow less friction between pump components. Less energy is required to operate the pump due to better suction and discharge performance of the pump, thus requiring less maintenance than other types of bearings.

The pump comprises sleeves 50a, 50b pressed onto the shafts 42, 44 which provide strength to the shafts 42, 44. More particularly, the sleeves comprise an inner race for the bearing, which is pressed onto the shafts 42, 44. The sleeves generally increase the life of the bearing and the shafts because the bearing and sleeve, or inner race, are constructed of the same metals and therefore have the same hardness. This design enables the use of unlimited types of material to make the pump shafts. Additional sealing and gearing elements 52 are provided and generally housed within pump housing features 40, 54. Pressure safety means are provided, including exhaust port housing 56 for containing a safety valve.

The pump has seals comprised of mechanical seals, spring seals, packed seals, porcelain seals, spring reinforced lip seals, or any seal that physically fits the housing and shaft of the pump of the present invention. Preferably, the pump has high-pressure lip seals.

Devices of the present invention have been shown to provide significant, unexpected, and non-obvious improvements over prior art devices. As further illustrated by representative test data provided below, a 1.5″ pump comprising features of the present invention has been shown to achieve efficiency levels between approximately 93% and 98%.

TABLE 1
1.5″ Pump with Short Impellers @ 0 PSI

| | Vacuum | | | |
|---|---|---|---|---|
| RPM | (PSI) | GPM | Theor. GPM | % Efficiency |
| 100 | 23.5 | 5 | 5.6 | 89% |
| 200 | 24 | 10 | 11.2 | 89% |
| 300 | 24 | 16 | 16.8 | 95% |
| 400 | 24 | 22 | 22.4 | 98% |
| 500 | 23 | 27 | 28 | 96% |
| 600 | 23.5 | 31 | 33.6 | 92% |
| 700 | 23 | 36 | 39.2 | 92% |
| 800 | 23 | 39 | 44.8 | 87% |
| 900 | 23 | 44 | 50.4 | 87% |
| 1000 | 23 | 47 | 56 | 84% |
| 1100 | 22.5 | 52 | 61.6 | 84% |

TABLE 2
1.5″ Pump with Long Impellers @ 0 PSI

| RPM | Vacuum | GPM | Theor. GPM | % Efficiency |
|---|---|---|---|---|
| 100 | 22.5 | 8 | 7.7 | 104% |
| 200 | 23 | 14 | 15.4 | 91% |
| 300 | 23 | 22 | 23.1 | 95% |
| 400 | 23 | 28 | 30.8 | 91% |
| 500 | 23 | 34 | 38.5 | 88% |
| 600 | 22.5 | 41 | 46.2 | 89% |
| 700 | 23 | 46 | 53.9 | 85% |
| 800 | 22.5 | 52 | 61.6 | 84% |
| 900 | 22.5 | 56 | 69.3 | 81% |

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims. Further, the invention(s) described herein are capable of other embodiments and of being practiced or of being carried out in various ways. In addition, it is to be understood that the phraseology and terminology used herein is for the purposes of description and should not be regarded as limiting. The use of “including,” “comprising,” or “adding” and variations thereof herein are meant to encompass the items listed thereafter and equivalents thereof, as well as, additional items.

What is claimed is:

1. A rotary pump, comprising:
a pump chamber having an interior chamber wall;
a first impeller and a second impeller disposed within said pump chamber, each of said impellers comprising:
a hub located substantially in the center of said first impeller and said second impeller, wherein each of said hubs rotates around a central axis of each of said impellers;
a plurality of lobes extending radially outward from each of said central axes, each of said lobes having a first end and a distal end, said distal end positioned proximate to said pump chamber;
said distal end comprising a substantially arcuate periphery;
a substantially arcuate cut-out portion between each of said lobes on said impellers, each of said arcuate cut-out portions having a conjugate surface;
each of said lobes comprising a plurality of wiper inserts, wherein each of said wiper inserts operatively engages a conjugate surface when each of said distal ends of each of said lobes is proximate to each of said conjugate surfaces;
wherein said plurality of wiper inserts are radially distributed about said substantially arcuate periphery such that at least one of said wiper inserts is in contact with at least one of said impellers throughout rotation of said impellers;
each of said lobes further comprising at least a first and second facial wiper insert;
said first facial wiper inserts extending outwardly and substantially perpendicular to a top plane of the lobe and extending from said first end of said lobe to said distal end of said lobe such that the first facial wiper bisects said top plane;
said second facial wiper inserts extending outwardly and substantially perpendicular to a bottom plane of the lobe and extending from said first end of said lobe to said distal end of said lobe such that the second facial wiper bisects said bottom plane; and
a drive shaft interconnected to each of said hubs, wherein each of said drive shafts independently rotate each of said hubs and said impellers to operatively move fluid through said pump chamber.

2. The rotary pump of claim 1, wherein said first and second facial wiper inserts further comprise a biasing means for providing a force to each of said first and second facial wiper inserts in a direction radially outward from said top and bottom plane of said lobe.

3. The rotary pump of claim 1, wherein said lobe further comprises a cavity and wherein said facial wiper inserts operatively engage said cavity such that said facial wiper inserts are substantially retained in said lobe.

4. The rotary pump of claim 3, wherein said cavity is in the form of a track and wherein a portion of said facial wiper inserts is retained in said track such that said facial wiper inserts are substantially impeded from becoming disengaged from said lobe.

5. The rotary pump of claim 1, wherein each of said plurality of wiper inserts have a plurality of apertures.

6. An impeller capable of being rotated within a chamber of a rotary pump, said chamber having an interior chamber wall, said impeller comprising:
at least one lobe extending radially outward from a hub interconnected to a drive shaft, the at least one lobe having a first end and a second end, said first end being proximate to said chamber wall and said second end being proximate to said drive shaft;
said first end comprising a plurality of wiper inserts, said wiper inserts being radially distributed about a periphery of said at least one lobe;
each of said wiper inserts comprising a blade portion and a biasing portion for operative engagement of said interior chamber wall;
each of said lobes further comprising a first and second facial wiper insert;
said first facial wiper extending outwardly normal to the top plane of the lobe and extending from said first end of said lobe to said second end of said lobe such that the second facial wiper bisects said top plane; and
said second facial wiper extending outwardly normal to the bottom plane of the lobe and extending from said first end of said lobe to said second end of said lobe such that the second facial wiper bisects said bottom plane; and
said facial wiper inserts comprising a biasing element for providing a force to each of said wiper inserts in a direction substantially normal to the face of the lobe such that said facial wiper inserts are in contact with said pump chamber.

7. The impeller of claim 6, wherein each of said facial wiper inserts are comprised of a rubber, a nitrile, a viton, a teflon, a polymer, a nylon based resin, or a foam rubber and combinations thereof.

8. The impeller of claim 6, wherein each of said biasing elements is selectively removable from each of said facial wiper inserts.

9. The impeller of claim 6, wherein at least one of said biasing elements is a leaf spring.

10. The impeller of claim 6, wherein said impeller comprises a cavity operably sized to receive a portion of said facial wiper inserts and having a general configuration which substantially impedes said facial wiper insert from becoming disengaged from said impeller.

11. The impeller of claim 6, wherein said impeller comprises a wiper insert stop, said wiper insert stop preventing said wiper insert from dislodging when said impeller rotates.

12. The impeller of claim 10, wherein said cavity is a track and wherein a portion of said facial wiper inserts is retained in said track such that said facial wiper inserts are substantially impeded from becoming disengaged from said lobe.

13. The impeller of claim 6, wherein said facial wiper inserts operatively engage said chamber of said rotary pump.

14. The impeller of claim 6, wherein said wiper inserts further comprise a plurality of apertures.

15. The impeller of claim 6, wherein said biasing element is comprised of metal, plastic, rubber, or polymers with expansion properties.

16. A rotary pump, comprising:
an interior chamber wall;
a first and second impeller located within said interior chamber wall, each of said first and said second impellers having a plurality of lobes and an equal amount of substantially arcuate cut-out portions alternatively surrounding a hub, said hub positioned substantially in the center of each of said impellers, said arcuate cut-out portions having a conjugate surface;
a plurality of wiper inserts interconnected to each of said lobes, said wiper inserts of said first impeller and said wiper inserts of said second impeller radially distributed about the distal ends of said lobes such that said wiper inserts of said first impeller contact said second impeller and said wiper inserts of said second impeller contact said first impeller in an alternating manner;
each of said wiper inserts comprising a blade portion and a biasing portion, said blade portions adapted to provide a force upon each of said wiper inserts in a direction which is outward from said hub;
each of said lobes further comprising a first and second facial wiper insert;
said first facial wiper extending outwardly normal to the top plane of the lobe and extending from said first end of said lobe to said second end of said lobe such that the second facial wiper bisects said top plane;
said second facial wiper extending outwardly normal to the bottom plane of the lobe and extending from said first end of said lobe to said second end of said lobe such that the second facial wiper bisects said bottom plane;
said facial wiper inserts comprising a biasing element for providing a force to each of said wiper inserts in a direction normal to the face of the lobe; and
an independent drive shaft interconnected each of said first and second impellers, wherein as said first and second impellers rotate said wiper inserts operatively engage said interior chamber wall to push a fluid through said rotary pump.

17. The rotary pump of claim 16, wherein said facial wiper inserts interconnected to said lobes of said first impeller operatively engage said pump chamber, and said facial wiper inserts interconnected to said lobes of said second impeller operatively engage said pump chamber.

18. The rotary pump of claim 16, wherein said impellers comprise a cavity operably sized to receive a portion of said facial wiper inserts and having a general configuration which substantially impedes said facial wiper insert from becoming disengaged from said impeller.

19. The rotary pump of claim 16, wherein said facial wiper inserts are selectively interconnected to said lobe.

20. The rotary pump of claim 16, wherein each of said plurality of wiper inserts have a plurality of apertures.
